(19) United States
(12) Patent Application Publication
(10) Pub. No.: US 2012/0000994 A1
(43) Pub. Date: Jan. 5, 2012

(54) DEVICE FOR INJECTING FUEL

(76) Inventors: Juergen Graner, Sersheim (DE); Martin Maier, Moeglingen (DE); Michael Huebel, Gerlingen (DE); Guenther Hohl, Stuttgart (DE)

(21) Appl. No.: 13/138,122

(22) PCT Filed: Nov. 27, 2009
(86) PCT No.: PCT/EP2009/065956

§ 371 Date: Sep. 22, 2011

(30) Foreign Application Priority Data
Jan. 13, 2009 (DE) 10 2009 000 186.7

(51) Int. Cl. F02M 61/16

(52) U.S. Cl. 239/533.3

(57) ABSTRACT

A device for injecting pressurized fuel includes an electrodynamic actuator having a movably situated coil, an outwardly opening needle which opens and closes a cross section on a valve seat, a connecting device which connects the needle to the movably situated coil, a pressure chamber which is situated at the needle upstream from the valve seat and contains pressurized fuel, a low-pressure chamber from which, fuel is dischargeable, and a gap seal which is provided at an outer peripheral region of the needle, the gap seal (16) providing a connection between the pressure chamber and the low-pressure chamber.

### BACKGROUND OF THE INVENTION

1. Field of the Invention

The present invention relates to a device for injecting fuel, in particular pressurized fuel being injected into a combustion chamber of an internal combustion engine.

2. Description of Related Art

Known devices are used, for example, in the injection of fuel in vehicle engines. Besides injection of diesel fuel, gasoline is recently also injected. Frequently, the fuel is provided under pressure in a storage system (rail) and injected via the device into a combustion chamber or an intake manifold. Electromagnetic actuators on the one hand, or alternatively, piezoelectric actuators on the other hand, are used as actuators. Electromagnetic actuators are relatively inexpensive, but are relatively slow. On the other hand, piezoelectric actuators are fast but relatively expensive. It would therefore be desirable to have a device which has an actuator that is relatively fast and yet inexpensive.

### BRIEF SUMMARY OF THE INVENTION

The device according to the present invention for injecting fuel has the advantage over the related art that it has short switching times and yet is manufacturable in a cost-effective manner. In addition, the device according to the present invention is also able to easily carry out two or more injections per cycle. The device according to the present invention may have an outwardly opening nozzle, thus allowing very good jet stability as well as a large diameter at the valve seat. This is achieved according to the present invention in that the device has an electrodynamic drive in which a movable coil is provided. In this way the drive may be provided cost-effectively, and rapid reversals of the motion of the coil may be achieved by reversing the current feed to the coil. In addition, the device according to the present invention includes an outwardly opening needle, and a connecting element which connects the coil to the needle. In addition, the needle may be actively opened and closed, respectively, by reversing the current direction.

The electrodynamic drive preferably includes a first permanent magnet and a second permanent magnet, a spacer disk which is situated between the first and second permanent magnets, the movable coil, and a magnetically conductive casing. A compact and simple design may be achieved in this way.

The connecting element which connects the needle to the electrodynamic drive also preferably includes a plurality of fingers. A secure connection between the needle and the electrodynamic drive may thus be achieved, and fuel is able to flow through between the fingers. The needle also includes a spring washer on which a closing spring is supported. The connecting element is connected to the spring washer via the fingers.

The device also preferably includes a fuel supply line which supplies pressurized fuel to a pressure chamber, the fuel supply line being guided through the electrodynamic drive in a tube. A particularly simple and compact design of the device may be achieved in this way.

The device also preferably includes a fuel return line which connects a low-pressure chamber to a return line. The fuel return line is particularly preferably guided through the electrodynamic drive in a tube in order to achieve a particularly compact design.

According to another preferred embodiment of the present invention, the device includes a corrugated bellows which delimits the low-pressure chamber. Simple and secure sealing of the low-pressure chamber may be achieved in this way.

In addition, the fuel supply line preferably includes a central needle hole which is provided in the needle. The central needle hole is connected to the pressure chamber via a transverse hole. Fuel may thus be supplied to the needle and to the pressure chamber, which allows a particularly simple and compact design.

An end section of the tube is particularly preferably designed as a guide section for the needle. High guiding accuracy of the needle may be ensured in this way.

To provide a particularly compact design, a subarea of the fuel supply line and a subarea of the fuel return line are. guided in parallel within the tube.

According to another preferred embodiment of the present invention, the corrugated bellows is situated between the connecting element and the spring washer. A lift of the connecting element is thus transferred to the needle via the corrugated bellows. Particularly simple and secure sealing may thus be achieved with the aid of the corrugated bellows.

The present invention is preferably used in internal combustion engines in which fuel under high pressure is injected from a storage system (rail).

### BRIEF DESCRIPTION OF THE DRAWINGS

FIG. 1 shows a schematic sectional view of a device according to a first exemplary embodiment of the present invention.

FIG. 2 shows a schematic sectional view of a device according to a second exemplary embodiment of the present invention.

FIG. 3 shows a schematic sectional view of a device according to a third exemplary embodiment of the present invention.

FIG. 4 shows a schematic sectional view of a device according to a fourth exemplary embodiment of the present invention.

FIG. 5 shows a schematic sectional view of a device according to a fifth exemplary embodiment of the present invention.

### DETAILED DESCRIPTION OF THE INVENTION

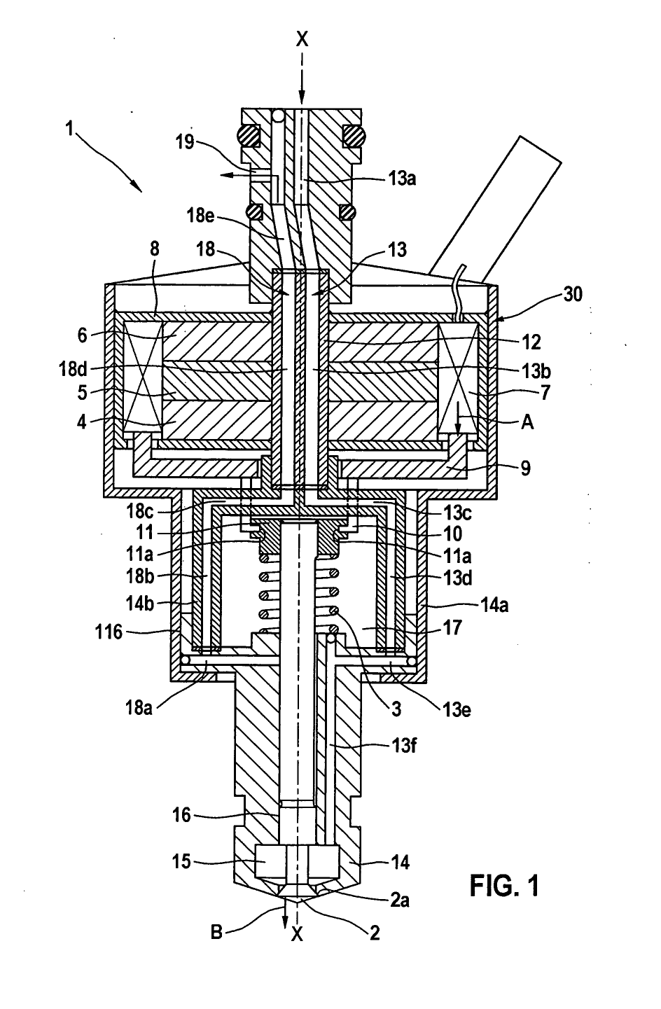

A device 1 for injecting fuel which is under high pressure is described in greater detail below with reference to FIG. 1.

As is apparent in FIG. 1, device 1 includes an electrodynamic actuator 30, a needle 2, a fuel supply line 13 in which fuel under high pressure is supplied, and a fuel return line 18 in which fuel under lower pressure is returned. Electrodynamic actuator 30 includes a first permanent magnet 4, a second permanent magnet 6, and a spacer disk 5. Spacer disk 5 is made of a magnetically conductive material, and is situated between first permanent magnet 4 and second permanent magnet 6. Electrodynamic actuator 30 also includes a movably situated coil 7 which is situated at the outer periphery of first and second permanent magnets 4, 6 and of spacer disk 5. A casing 8 which is made of a magnetically conductive material encloses coil 7 and the end faces of first permanent magnet 4 and second permanent magnet 6. The two permanent magnets 4, 6 are situated in such a way that the same poles face spacer disk 5. The permanent magnets thus form a magnetic field over spacer disk 5 which extends radially outwardly toward casing 8. When coil 7 is then supplied with current, coil 7 experiences a Lorentz force which, depending on the current direction, acts in an opening or a closing direction (i.e., axial direction) and moves coil 7 in the appropriate direction.

Device 1 also includes a closing spring 3 which rests against a spring washer 11 which is fixed on needle 2. In addition, a connecting device 9 is provided which has an essentially cup-shaped design and is connected at its free end to movable coil 7. Multiple fingers 10 are provided at the base region of connecting device 9 and are situated in correspondingly configured openings 11a in spring washer 11. Fingers 10 are fixed in spring washer 11 in such a way that the spring washer may be moved upwardly and downwardly in the axial direction by moving connecting device 9. Spring washer 11 is fixedly connected to needle 2, resulting in movement of needle 2. As is further apparent from FIG. 1, closing spring 3 is supported between an inner side of a housing 14 and spring washer 11.

As is further apparent from FIG. 1, a tube 12 passes through the center of electrodynamic actuator 30 in axial direction X-X. Fuel supply line 13 as well as fuel return line 18 extends through tube 12. As is apparent from FIG. 1, fuel supply line 13 includes multiple line sections 13a, 13b, 13c, 13d, 13e, 13f. Fuel return line 18 likewise includes multiple line sections 18a, 18b, 18c, 18d, 18e. Alternatively, line section 18c is directly connected to low-pressure chamber 17. In that case line sections 18a, 18b may be dispensed with. The fuel is discharged from device 1 via an outlet hole 19. Line sections 13a through 13f are situated on the one hand in housing 14, and on the other hand in various intermediate components. Fuel supply line section 13b extends through the center of section actuator 30, parallel to fuel return line section 18d. Fuel supply line 13 opens into an annular pressure chamber 15 situated at valve seat 2a of needle 2. Starting from annular pressure chamber 15, small quantities of fuel are able to flow back via a gap seal 16, provided between needle 2 and housing 14, to fuel return line 18, i.e., to a low-pressure chamber 17. As is apparent from FIG. 1, closing spring 3 and a portion of needle 2 are situated in low-pressure chamber 17.

Device 1 according to the present invention functions as follows. Fuel which is already under pressure is supplied, for example, from a rail to annular pressure chamber 15 via fuel supply line 13. Electrodynamic actuator 30 is activated if fuel is to be injected. For this purpose, coil 7 is supplied with current so that coil 7 moves downwardly, as indicated by arrow A in FIG. 1. Since coil 7 is fixedly connected to connecting device 9, connecting device 9 is also moved downwardly. Needle 2 is then moved in the direction of arrow B via fingers 10 and spring washer 11, causing the needle to be lifted off from its valve seat 2a. Fuel is injected in this way. Closing spring 3 is compressed by the motion of needle 2 together with spring washer 11. Since closing spring 3 and spring washer 11 are situated in low-pressure chamber 17, it is only necessary to overcome the elastic force of closing spring 3 in order to open needle 2. To conclude the injection, the current direction at coil 7 is reversed, causing coil 7 to once again move toward the starting position, as shown in FIG. 1. Since coil 7 is fixedly connected to connecting device 9, and is connected to needle 2 via fingers 10 and spring washer 11, needle 2 is closed. Closing spring 3 also assists in this process. The injection of fuel is thus concluded.

According to the present invention, needle 2 may thus be actively opened and closed by reversing the current direction at coil 7. Very brief closing times are achieved which are significantly shorter than closing times for electromagnetic actuators, for example. Device 1 nevertheless has a very compact and in particular also robust design, so that device 1 provides a long service life. In addition, by use of the device according to the present invention in particular a large cross section at valve seat 2a may be achieved, so that large quantities of fuel may be injected with short opening times. Short opening intervals in particular may be achieved in this way.

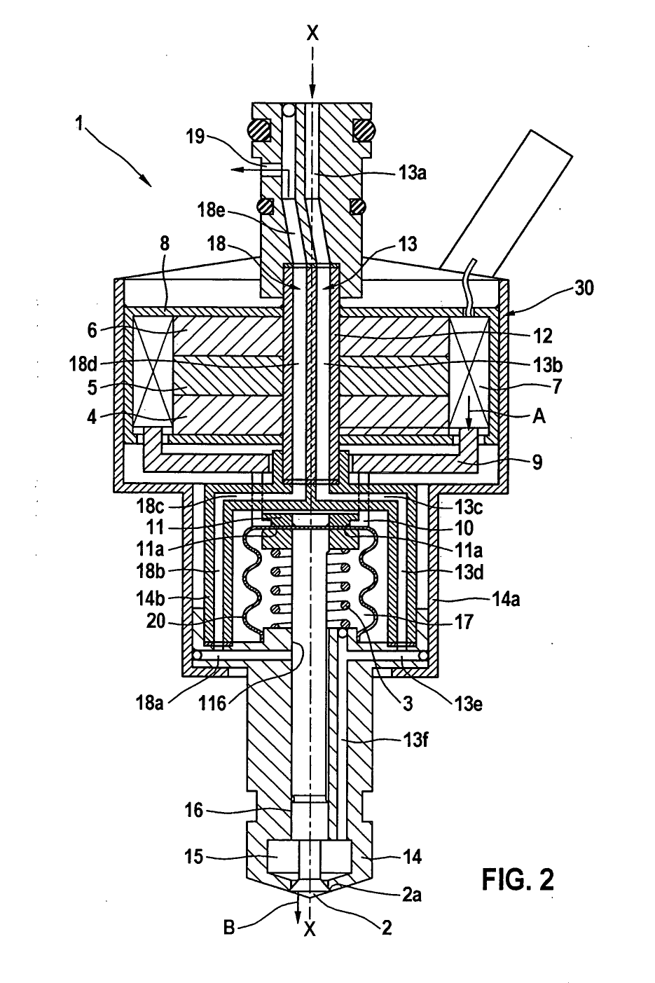

A device 1 according to a second exemplary embodiment of the present invention is described in greater detail below with reference to FIG. 2. Identical or functionally equivalent parts are denoted by the same reference numerals as in the first exemplary embodiment. The second exemplary embodiment essentially corresponds to the first exemplary embodiment, except that in the second exemplary embodiment low-pressure chamber 17 is defined by a wave spring 20. As is apparent from FIG. 2, wave spring 20 is fixed to spring washer 11 on the one hand and to the inner side of housing 14 on the other hand. This allows simple sealing of low-pressure chamber 17. In other respects, this exemplary embodiment corresponds to the preceding exemplary embodiment, so that reference may be made to the description provided therein.

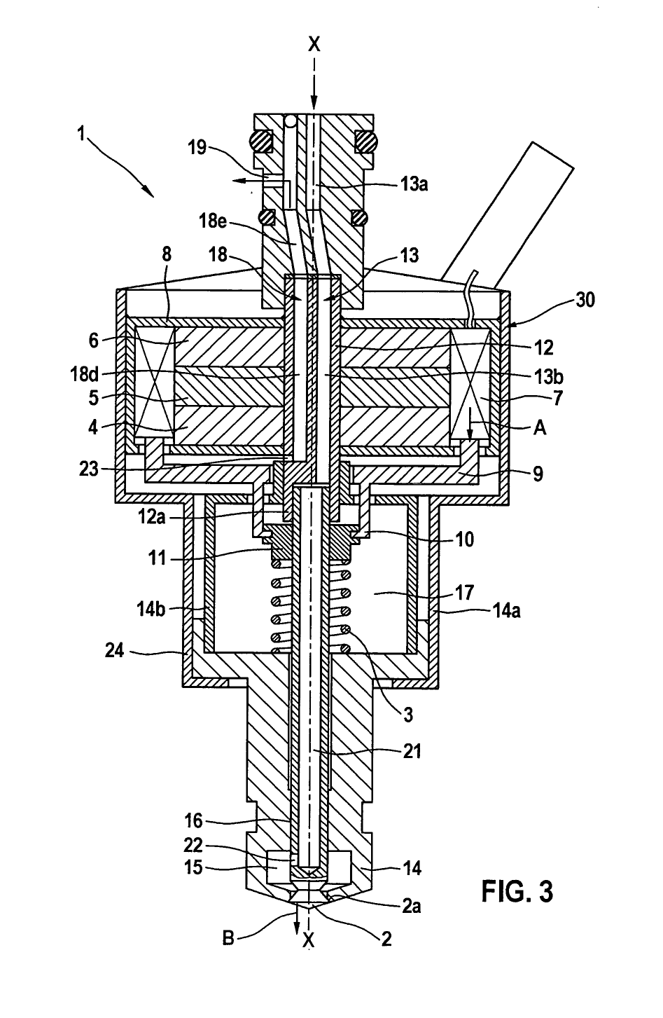

FIG. 3 shows a device 1 according to a third exemplary embodiment of the present invention, identical or functionally equivalent parts once again being denoted by the same reference numerals as in the preceding exemplary embodiments. The third exemplary embodiment essentially corresponds to the first exemplary embodiment, except that in the present case the designs of fuel supply line 13 and fuel return line 18 are different. As is apparent from FIG. 3, fuel supply line 13 is guided through a central needle hole 21 in needle 2. Central needle hole 21 is connected to annular pressure chamber 15 via a transverse hole 22. As is further apparent from FIG. 3, in this exemplary embodiment low-pressure chamber 17 is directly connected to a fuel return line section 18d via a transverse hole 23. Fuel supply line 13 and fuel return line 18 in particular may thus be simplified in this exemplary embodiment. In addition, in the third exemplary embodiment one end of needle 2a facing electrodynamic actuator 30 is guided in an end section 12a of tube 12. A second guide for needle 2 is provided by housing 14. In other respects, this exemplary embodiment corresponds to the preceding exemplary embodiment, so that reference may be made to the description provided therein.

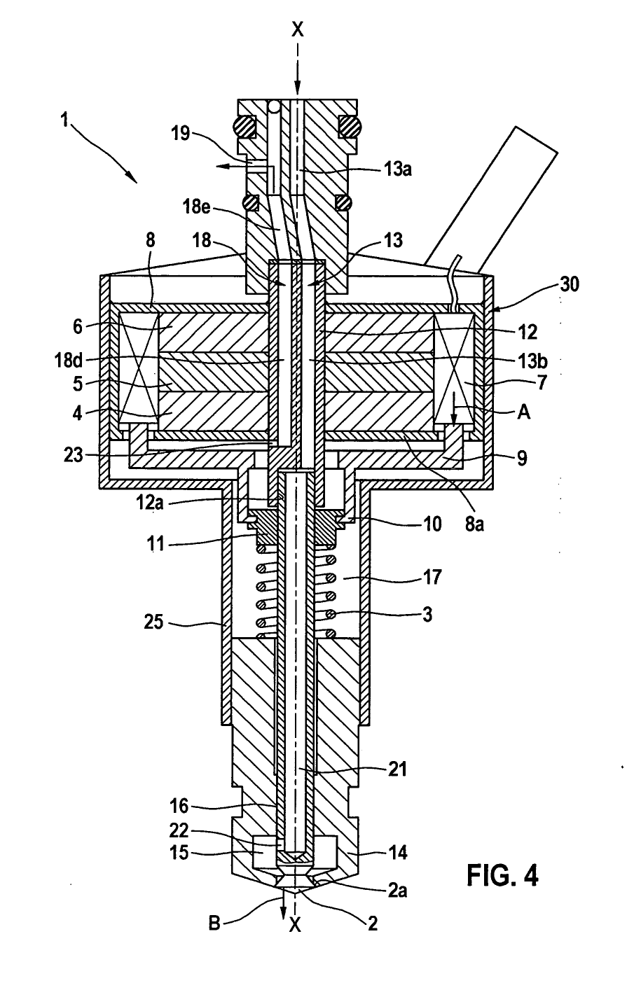

A device 1 according to a fourth exemplary embodiment of the present invention is described in greater detail below with reference to FIG. 4. Identical or functionally equivalent parts are once again denoted by the same reference numerals as in the preceding exemplary embodiments.

The fourth exemplary embodiment essentially corresponds to the third exemplary embodiment except that, in contrast to the third exemplary embodiment, device 1 of the fourth exemplary embodiment has an even more compact design. For this purpose, a volume of low-pressure chamber 17 is reduced, and in addition an alternative guide design for needle 2 is implemented. For this purpose, a housing element 25 is centered over casing 8 of dynamic actuator 30. In addition, a lower casing section 8a ensures positioning of tube 12, and the upper end of needle 2 is guided in end section 12a of tube 12. A particularly compact design may be achieved in this way.

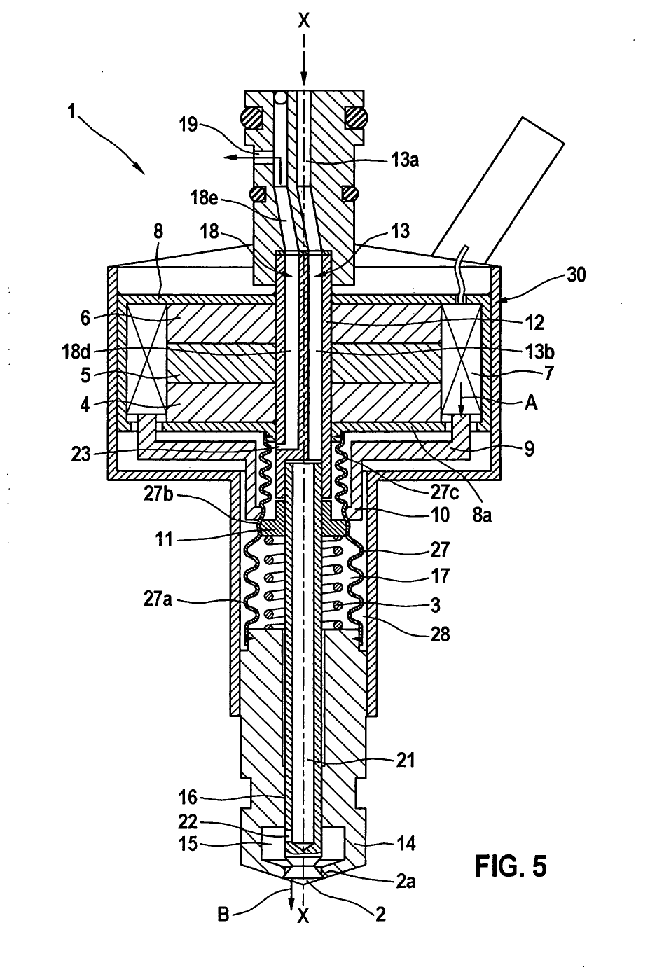

FIG. 5 shows a fifth exemplary embodiment of the present invention, identical or functionally equivalent parts once again being denoted by the same reference numerals as in the preceding exemplary embodiments.

The fifth exemplary embodiment essentially corresponds to the fourth exemplary embodiment, with the additional provision of a metallic corrugated bellows 27. Corrugated bellows 27 separates low-pressure chamber 17 from a pressure-free space 28. Corrugated bellows 27 has an enlarged diameter at an end 27a facing the injection opening. This allows spring washer 11 to be mounted from the bottom, i.e., through the interior of the corrugated bellows. Corrugated bellows 27 has a relatively elongated design in the axial direction, and its diameter decreases at end 27c facing electrodynamic actuator 30. In a transition region 27b of corrugated bellows 27, spring washer 11 comes into contact with corrugated bellows 27 from the inner side thereof, and fingers 10 of connecting device 9 are situated on the outside of corrugated bellows 27. This design of corrugated bellows 27 allows fingers 10 together with connecting device 9 to be mounted from the top. In addition, a lift of coil 7 is thus transferred via connecting device 9 and fingers 10, and via corrugated bellows 27 to spring washer 11, and from there to needle 2. In other respects, this exemplary embodiment corresponds to the preceding exemplary embodiments, so that reference may be made to the description provided therein.

1-11. (canceled)

12. A device for injecting pressurized fuel, comprising:
an electrodynamic actuator having a movably situated coil;
an outwardly opening needle configured to open and close a cross section on a valve seat;
a connecting device which connects the needle to the movably situated coil;
a first pressure chamber situated at the needle upstream from the valve seat and containing pressurized fuel;
a low-pressure chamber configured to discharge fuel; and
a gap seal provided at an outer peripheral region of the needle, wherein the gap seal provides a connection between the first pressure chamber and the low-pressure chamber.

13. The device as recited in claim 12, wherein the electrodynamic actuator includes a first permanent magnet, a second permanent magnet, a spacer disk, and a casing, the spacer disk being situated between the first permanent magnet and the second permanent magnet, and the movable coil being situated at the outer periphery of the first and second permanent magnets.

14. The device as recited in claim 12, further comprising: a closing spring situated at the needle and configured to close the needle after the needle has been opened.

15. The device as recited in claim 14, wherein:
the connecting device includes multiple fingers;
the needle includes a spring washer fastened to the needle;
the closing spring is supported on the spring washer; and the connecting device is fixedly connected to the spring washer via the fingers.

16. The device as recited in claim 12, wherein a fuel supply line is guided through the electrodynamic actuator in a tube, and wherein the pressurized fuel is supplied to the first pressure chamber via the fuel supply line.

17. The device as recited in claim 16, wherein a fuel return line is guided through the electrodynamic actuator in the tube, and wherein the fuel return line discharges fuel from the low-pressure chamber.

18. The device as recited in claim 15, wherein a corrugated bellows delimits the low-pressure chamber.

19. The device as recited in claim 16, wherein the fuel supply line includes a central needle hole formed in the needle, and wherein the central needle hole is connected to the first pressure chamber via a transverse hole.

20. The device as recited in claim 16, wherein one end of the needle facing away from the valve seat is guided in a guide section of the tube.

21. The device as recited in claim 17, wherein a subarea of the fuel supply line and a subarea of the fuel return line are guided in parallel in the tube.

22. The device as recited in claim 18, wherein the corrugated bellows is situated between the connecting device and the spring washer, and a lift of the connecting device is transferred to the needle via the corrugated bellows.
